(19) United States
(12) Patent Application Publication
(10) Pub. No.: US 2009/0020111 A1
(43) Pub. Date: Jan. 22, 2009

(54) Device for cooking pizzas and barbecues

(76) Inventor: Gerard Immordino, Marseille (FR)

Correspondence Address: BACHMAN & LAPOINTE, P.C., 900 CHAPEL STREET, SUITE 1201, NEW HAVEN, CT, 06510, US

(21) Appl. No.: 11/886,940

(22) PCT Filed: Mar. 21, 2006
(86) PCT No.: PCT/FR2006/000613

§ 371 Date: Oct. 1, 2008

(30) Foreign Application Priority Data
Mar. 21, 2005 (FR) 0502744

(51) Int. Cl. A47J 37/00

(52) U.S. Cl. 126/9 R

(57) ABSTRACT

A device for cooking pizzas and barbecues has a dome-shaped upper portion forming an oven and provided at its summit with an orifice. The wood or gas oven, collapsible and mobile, comprises both a smoke evacuating system for maintaining a high temperature therein and an ash recovery system. It is supported on a carriage with racks for utensils and tray for storing wood, and comprises wheels, one of which is steerable equipped with a brake, which make it easy to move. The device is designed for domestic usage. Any person possessing a plot of land, a terrace or a balcony can use the oven. It can be commercialized in specialized superstores, but not exclusively.

### BACKGROUND OF THE INVENTION

(1) Field of the Invention

The present invention relates to a device for cooking pizzas and barbecues. This wood- or gas-fired oven is collapsible and mobile, and comprises both a smoke-evacuation system for maintaining a high temperature therein and an ash recovery system.

(2) Prior Art

Wood-fired pizza ovens currently available commercially are refractory ovens requiring masonry work and thus the intervention of a professional.

Immobile and non collapsible, they occupy considerable space and their weight is significant. Also, building these ovens requires considerable wait time prior to use, due to the humidity associated with masonry work. The risk from premature use is cracking. The disadvantage of these ovens is that once built on a specific site, they cannot be shifted.

### SUMMARY OF THE INVENTION

The device according to the invention remedies these drawbacks. In fact, this innovation democratises pizza ovens:

It is made of food-quality cast iron, since its components, in the finished product state, are designed to enter into direct contact with foodstuffs, with regular usage, also making it a material of choice as much by its resistance to shock and oxidation as by its heat conservation capacity.

It is collapsible since it is made of several superposed elements fitting into one another by way of. male and female parts ensuring stability and tightness of the ensemble, the whole improved by the intrinsic weight of the oven.

The upper part of the oven comprises, at the top and centre, a chimney for evacuation of fumes. This oven offers the double advantage of being used as barbecue with optional removal of the upper the parts and with placing a cooking grille on the first element of the base of the oven.

The part on which the food rests is either a refractory hearth, or an assembly of refractory bricks. This hearth rests on a metal or cast iron grille. Due to its rectangular shape, the embers can fall out and be recovered in the system in the shape of a funnel placed under the oven.

A system in the shape of a funnel, cone or trapeze (4 pans) is designed, once the temperature is sufficiently high, to receive the embers coming from the refractory hearth so as to heat them underneath and obtain turning heat. Its lower part has an opening system facilitating evacuation of the cold ashes for easy cleaning. The material making up this system will be either cast iron, or metal.

This oven, placed on a carriage composed of tubes or metal bars provided to support the weight of the whole, is made mobile due to wheels including a steerable wheel fitted with a brake.

### BRIEF DESCRIPTION OF THE DRAWINGS

The attached diagrams illustrate the invention:

FIG. 1 illustrates, in profile, the device in its entirety.

FIG. 2 illustrates the oven viewed from the front.

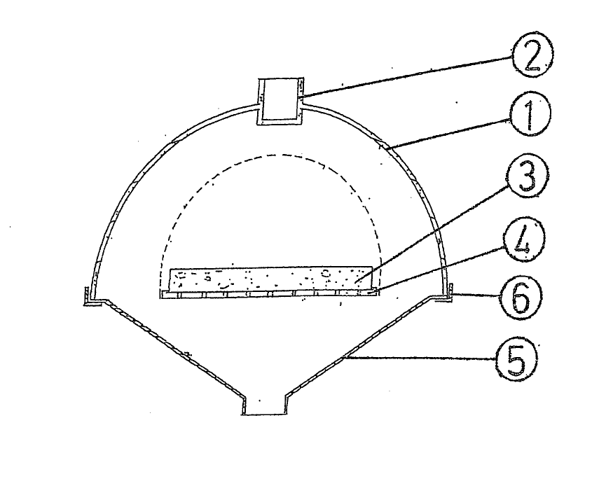

FIG. 3 illustrates the oven viewed in profile.

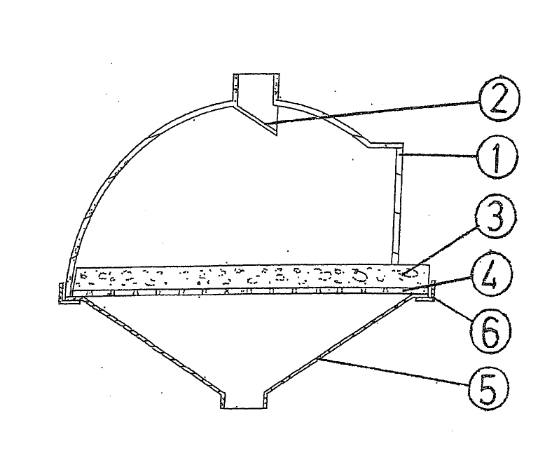

FIG. 4 illustrates the refractory hearth viewed from above.

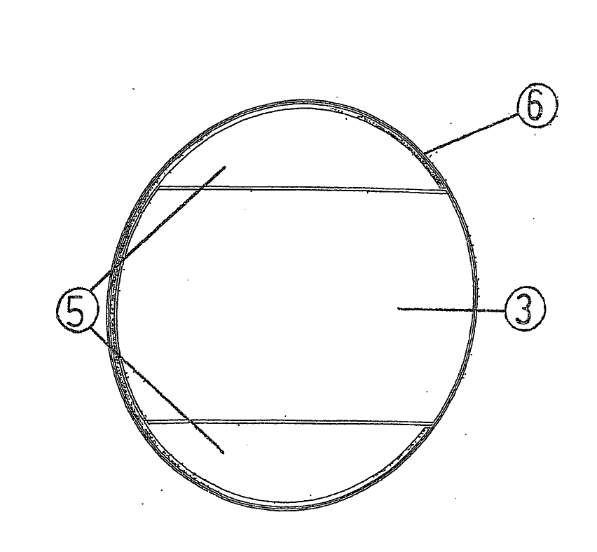

FIG. 5 illustrates the device in detail.

### DETAILED DESCRIPTION OF THE PREFERRED EMBODIMENT(S)

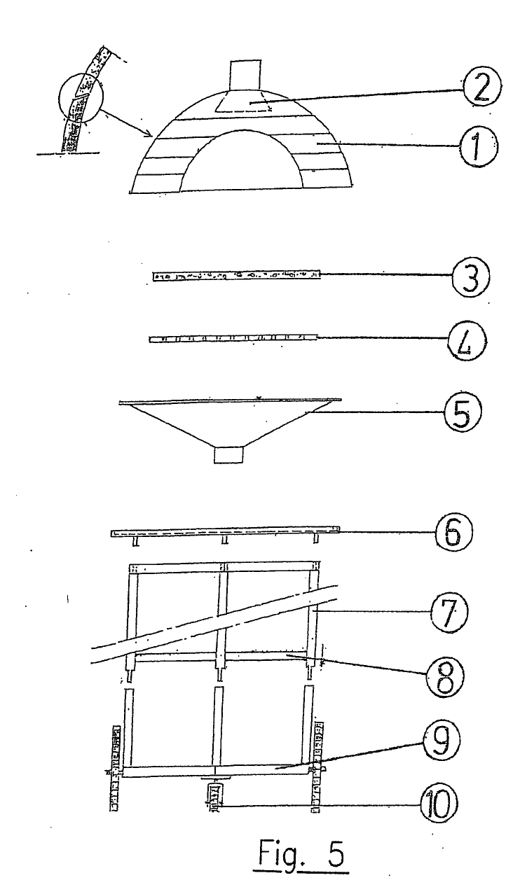

In reference to these diagrams, the device (FIG. 5) comprises an upper part (1) in the form of a dome constituted by an arched lid made of cast iron, which can be, externally, enamelled to offer better aesthetics to users. It is composed of several simple elements either circular, or in quarters, superposed and fitted in to one another using a “male female” system. This nesting system can be bevelled or saw-toothed. Assembling the different elements is easy as they only need to be placed on one another. Disassembly is made easy by handgrips moulded in each element allowing each to be portable.

The upper part (1) of the oven comprises an orifice (2) arranged on a sleeve capable of being equipped with equipment for discharging the fumes, a conduit extending from this orifice to the front of the oven inside the arched lid, terminating in a smaller passage for evacuation of fumes and avoiding excessive heat loss.

The refractory hearth (3) can be either segmented into several elements to facilitate its assembly, or into refractory bricks simply laid side by side. It is preferably rectangular in shape and of reduced size on two sides so that the embers can be poured to wards the evacuation system.

The hearth rests on a metal (4) or cast iron grille of circular, square or rectangular shape.

The device is fitted with a system (5), made of metal or cast iron, of conical shape located under the oven for collecting the ash coming from the hearth once the temperature of the oven is adequate. The wood fire heats the hearth from beneath. Also, this cone has a system for good distribution of the embers, ensuring homogeneous heat and cooking. It also comprises an opening, closed by a flap, in the narrowest lower part for easy evacuation, after use, of the embers recovered in a drawer provided for this purpose and located beneath the device.

The base of the oven will fit into a metal (6) or cast iron circle, fitted with three anchor points fixed on each angle of the upper part of the carriage.

The carriage (7) is collapsible and made of tubes or metal bars, and supports the weight of the oven, of the funnel device, of the hearth and of the grille. It comprises a rack (8) designed to receive the various utensils used in pizza cooking and the tray for storing wood (9). Its mobility is ensured by wheels including a steerable wheel (10) located at the front and fitted with a brake.

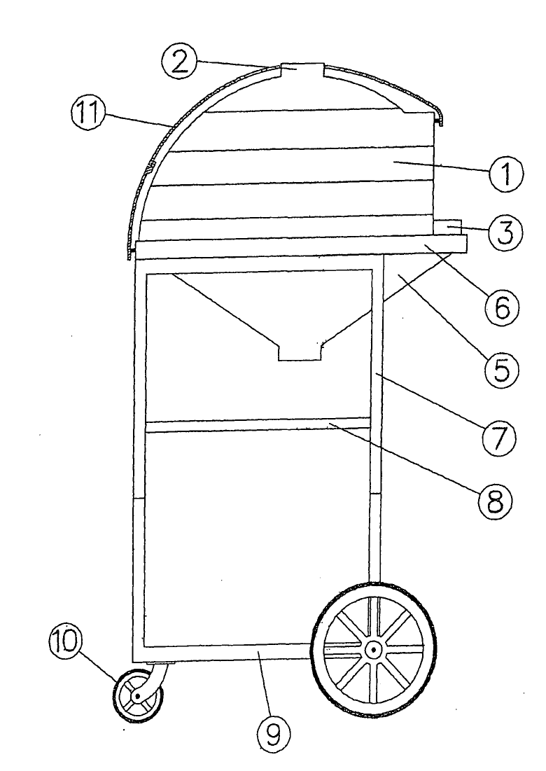

The arched lid could advantageously be covered by a perforated cupola (11), preferably made in two parts resting on one another. This cupola will be determined so as to provide between itself and the arched lid a space for circulation of air, to maintain it at a slightly raised temperature so as to prevent users from being burned (FIG. 1).

This invention is intended for domestic use. Any person having a plot of land, a terrace or a balcony can utilise this oven. It can be commercialised in a non-limiting manner in superstores.

1-9. (canceled)

10. A collapsible device designed for cooking foodstuffs which is wood- or gas-fired, said device comprising a refractory hearth and an upper part in the shape of a dome constituting an oven and fitted with an orifice for evacuation of fumes, said upper part being made of food-quality cast iron and composed of portable, nestable and superposable elements resting on one another, and said elements including a first element which constitutes a base of the oven.

11. The device as claimed in claim 10, further comprising a cooking grille placed on said first element, upper parts of the upper part of the device being removed so that the device is suitable for use in a barbecue.

12. The device as claimed in claim 10, further comprising a mobile collapsible carriage supporting the weight of the assembly and receiving the base of the oven.

13. The device as claimed in claim 12, wherein the base of the oven fits into a circle made of a metallic material fitted with anchor points fixed on an upper part of the carriage.

14. The device as claimed in claim 12, wherein the carriage comprises a rack for receiving various useful utensils and a storage tray, and wheels, including one steerable wheel.

15. The device as claimed in claim 10, wherein each said cast iron element comprises moulded handgrips.

16. The device as claimed in claim 10, wherein the refractory hearth on which rest the foodstuffs is of smaller size on two sides to allow passage of embers and ashes, and is placed in support on a cast iron grille, and is a recovery cone for embers and ashes placed under said refractory hearth, said recovery cone being fitted with a system for proper distribution of the embers, ensuring homogeneous heat and cooking and an opening system for evacuation of cold ashes for easy cleaning.

17. The device as claimed in claim 10, wherein the upper part comprises, from the orifice, a conduit extending inside an arched lid to a front of the oven, terminating in a narrow passage for fumes, so as to prevent excessive heat loss.

18. The device as claimed in claim 10, wherein the dome of the upper part is covered by a perforated cupola, arranged to provide between itself and the dome a space for circulation of air, to maintain a slightly temperature to prevent users from being burned.

19. The device as claimed in claim 18, wherein the cupola is made in two parts resting on one another.
